(19) United States
(12) Patent Application Publication
(10) Pub. No.: US 2019/0101185 A1
(43) Pub. Date: Apr. 4, 2019

(54) DRIVING BELT

(71) Applicant: TOYOTA JIDOSHA KABUSHIKI KAISHA, Toyota-shi (JP)

(72) Inventor: Keisuke NINOMIYA, Susono-shi (JP)

(73) Assignee: TOYOTA JIDOSHA KABUSHIKI KAISHA, Toyota-shi (JP)

(21) Appl. No.: 16/147,995

(22) Filed: Oct. 1, 2018

(30) Foreign Application Priority Data
Sep. 29, 2017 (JP) 2017-190677

(51) Int. Cl. F16G 5/16

(52) U.S. Cl. CPC F16G 5/16

(57) ABSTRACT

In a driving belt configured by binding a plurality of elements in loop form by a belt-like hoop, an opening width between a first hook section and a second hook section of the element is narrower than a width of the hoop. A first width from a center to a first pillar section is wider than a second width from the center to a second pillar section. A first clearance between a saddle surface and a lower surface of the first hook section is wider than a second clearance between the saddle surface and a lower surface of the second hook section. The second clearance is wider than a thickness of the hoop.

### CROSS REFERENCE TO RELATED APPLICATIONS

The present disclosure claims the benefit of Japanese Patent Application No. 2017-190677 filed on Sep. 29, 2017 with the Japanese Patent Office, the disclosure of which is incorporated herein by reference in its entirety.

### BACKGROUND

### Field of the Disclosure

Embodiments of the present disclosure relate to the art of a driving belt configured by arranging a plurality of plate-piece shaped elements with their postures aligned and binding the elements in loop form by a belt-like hoop.

### Discussion of the Related Art

JP-T-2017-516966 describes a driving belt for a continuously variable transmission. This driving belt described in JP-T-2017-516966 includes an endless carrier (a belt-like hoop) and a plurality of transverse members (plate-piece shaped elements). The element has a base section and two pillar sections. The two pillar sections are respectively formed at both ends in an axial direction (a width direction) of the base section. An opening and a saddle surface for assembling and disposing the hoop are formed between the two pillar sections. The elements are disposed in a line along a peripheral direction of the hoop. Furthermore, the element includes at least two types (type I, type II). In the type I element, a first pillar section which is one of the two pillar sections has a first hook section formed therein. The first hook section extends from the first pillar section toward a central portion in the width direction of the element and anchors the hoop that has been disposed on the saddle surface, thereby preventing shedding from the hoop of the elements. A second pillar section which is the other of the two pillar sections has formed therein a second hook section which is considerably smaller compared to the first hook section. In the type II element, the second pillar section which is the other of the two pillar sections has the first hook section formed therein. The first pillar section which is the one of the two pillar sections has formed therein the second hook section which is considerably smaller compared to the first hook section. That is, the type II element has a positional relationship of the first pillar section and the second pillar section reversed compared to the type I element. The type I elements and the type II elements are arranged alternately or in a random order. The first pillar section and the second pillar section of the elements each have formed therein a convex section (a boss section) and a concave section (a dimple section) that fit together with each other. By these boss section and dimple section fitting together, the fellow adjacent elements are positioned and have their relative movement restricted. Moreover, the hoop is disposed between each of the hook sections and the base section in each of the types of elements of the above-described kind, and the hoop binds the plurality of elements in loop form. As a result, the driving belt is configured.

As described above, the element of the driving belt described in JP-T-2017-516966 has the large first hook section formed only in one of the pillar sections. The second hook section formed in the other of the pillar sections is relatively small compared to the first hook section. For example, a projection length of the second hook section is set to a half or less of play between the opening and the hoop in the width direction of the element. Therefore, when the elements are in a single entity state, the second hook section will never be a hindrance when fitting the hoop into an opening portion at an element center, hence the elements and the hoop can be easily assembled. Moreover, by adopting an arrangement combining the two kinds of elements whose positions of the first hook section are symmetrical, both end portions in the width direction of the hoop are anchored by the first hook section of each of the elements, and shedding from the hoop of the elements is prevented. However, if, due to, for example, aging of the driving belt, there occur the likes of stretching of the hoop or abrasion or buckling of engaging portions of the elements, then there is a possibility that a gap between the adjacent elements increases, and, as a result, fitting together of the boss section and the dimple section of the elements gets undone. If fitting together of the boss section and the dimple section is undone, the elements end up attaining a state where they can move freely as single entities. If, in such a state, a vibration is transmitted to the driving belt, for example, and, due to effects of that vibration, the elements move in the width direction, then, since the second hook section is fairly small as described above, engagement of the second hook section and an end section of the hoop easily gets undone. As a result, there is a possibility that the elements end up falling in a gravity direction due to their own weight, for example. Therefore, there is a risk of the elements getting shed from the hoop.

Aspects of embodiments of the present disclosure have been conceived noting the foregoing technical problems, and it is therefore an object of the present disclosure to provide a driving belt that, in the case of it being a driving belt configured by assembling a hoop in an opening portion at a center in a width direction of elements, enables the elements and the hoop to be easily assembled and enables shedding of the elements from the hoop to be reliably prevented.

### SUMMARY

Embodiments of the present disclosure relates to a driving belt configured by arranging a plurality of plate-piece shaped elements and binding the elements in loop form by a belt-like hoop. In order to achieve the above-explained object, the element comprises: a base section forming a main body portion, a saddle surface formed at an upper end of the base section to contact an inner peripheral surface of the hoop; a first pillar section erected from the upper end of the base section at a first end section of the base section in a width direction of the element; a second pillar section erected from the upper end of the base section at a second end section of the base section in the width direction; a first hook section extending out from the first pillar section toward a center of the element in the width direction; and a second hook section extending out from the second pillar section toward the center. An opening width between a tip section of the first hook section and a tip section of the second hook section is narrower than a width of the hoop. A first width from the center to a base corner of the first pillar section is wider than a second width from the center to a base corner of the second pillar section. A first clearance between the saddle surface and a lower surface of the first hook section facing the saddle surface is wider than a second clearance between the saddle surface and a lower surface of the second hook section facing the saddle surface. The second clearance is wider than the thickness of the hoop.

In a non-limiting embodiment, a third width from the base corner of the first pillar section to the tip section of the second hook section of the element may be wider than the width of the hoop.

In a non-limiting embodiment, a recess to which an edge of the hoop is engaged to restrict a movement of the hoop may be formed on at least one of the lower surface of the first hook section and the saddle surface opposed to the lower surface of the second hook section.

In a non-limiting embodiment, the element may further comprise: a first boss projecting to the outside from a front surface of the first pillar section in a thickness direction of the element; a first dimple recessing to the inside from a rear surface of the first pillar section in the thickness direction; a second boss projecting to the outside from a front surface of the second pillar section in the thickness direction; and a second dimple recessing to the inside from a rear surface of the second pillar section in the thickness direction. In the fellow elements adjacent in a peripheral direction of the hoop, the first boss and the first dimple fit together, and the second boss and the second dimple fit together.

In a non-limiting embodiment, the element may further comprise: a boss projecting to the outside from the center of a front surface of the base section in the thickness direction of the element; and a dimple recessing to the inside from the center of a rear surface of the base section in the thickness direction. In the fellow elements adjacent in a peripheral direction of the hoop, the boss and the dimple fit together.

In a non-limiting embodiment, the element may include: a first element in which the first width is wider than the second width, and the first clearance is wider than the second clearance; and a second element in which the second width is wider than the first width, and the second clearance is wider than the first clearance. The first elements and the second elements may be juxtaposed not only alternately in a predetermined pattern but also at random.

In a non-limiting embodiment, a third width from the base corner of the first pillar section to the tip section of the second hook section of the first element may be wider than the width of the hoop. Likewise, a fourth width from the base corner of the second pillar section to the tip section of the first hook section of the second element may be wider than the width of the hoop.

In the driving belt of the present disclosure, dimensions of from the center of the base section to the base corner of the pillar section in the width direction of the element differ between left and right. On a side of the one of the pillar sections in which that dimension is larger, there is formed a space-for-assembly enabling the end section of the hoop to be fitted in to close to a root of the hook section when the elements and the hoop are assembled. Therefore, due to the present disclosure, the elements and the hoop can be easily assembled. Note that in the driving belt of the present disclosure, a dimension of from the base corner of the one of the pillar sections in which the above-described kind of space-for-assembly is formed to the tip section of the hook section on a side of the other of the pillar sections (that is, the third width or the fourth width) may be made larger than the width of the hoop. By doing so, the elements and the hoop can be even more easily assembled.

In addition, in the driving belt of the present disclosure, the first clearance between the saddle surface and the lower surface of the first hook section is wider than the second clearance between the saddle surface and the lower surface of the second hook section. Therefore, when the first hook section side of the element in which the first clearance is relatively larger sags under the influence of gravity, the hoop is stuck between the second hook section and the saddle surface and hence a lateral movement of the hoop in the width direction of the element is restricted. For this reason, disengagement of the element from the hoop can be prevented certainly even if a clearance between the adjacent elements is widened with age or abrasion.

### BRIEF DESCRIPTION OF THE DRAWINGS

Features, aspects, and advantages of exemplary embodiments of the present invention will become better understood with reference to the following description and accompanying drawings, which should not limit the invention in any way.

FIG. 1 is a view for explaining an example of a driving belt of the present disclosure, and is a view showing a state where the driving belt of the present disclosure has been wound on pulleys of a belt-driven transmission (a belt-type continuously variable transmission);

FIG. 2 is a view for explaining a configuration of the driving belt of the present disclosure, and is a front view showing a configuration of an element and a cross-sectional view showing a configuration of a hoop;

FIG. 3 is a view for explaining the configuration of the driving belt of the present disclosure, and is a side view (a partial cross-sectional view) showing configurations of the element and the hoop;

FIG. 4 is a view for explaining the configuration of the driving belt of the present disclosure, and is a view showing the configuration of the hoop;

FIG. 5 is a view for explaining an assemble of the driving belt of the present disclosure, and is a view showing a state where the hoop is inserted in a space-for-assembly formed in the element;

FIG. 6 is a view for explaining a function of the driving belt of the present disclosure, and is a view showing a state where the element 3 hangs on the hoop under the influence of gravity;

FIG. 7 is a view for explaining another example of the driving belt of the present disclosure, and is a view showing a structure of a second element;

FIG. 8 is a side view for showing an array of first elements and the second elements;

FIG. 9 is a view for explaining another example of the driving belt of the present disclosure in which a boss and a dimple are formed on a central portion of a base section of the element; and

FIG. 10 is a side view showing an array of the elements shown in FIG. 9.

### DETAILED DESCRIPTION OF THE PREFERRED EMBODIMENT(S)

Embodiments of the present disclosure will now be explained with reference to the accompanying drawings. Note that the embodiments shown below are merely examples of cases where the present disclosure has been actualized, and do not limit the present disclosure.

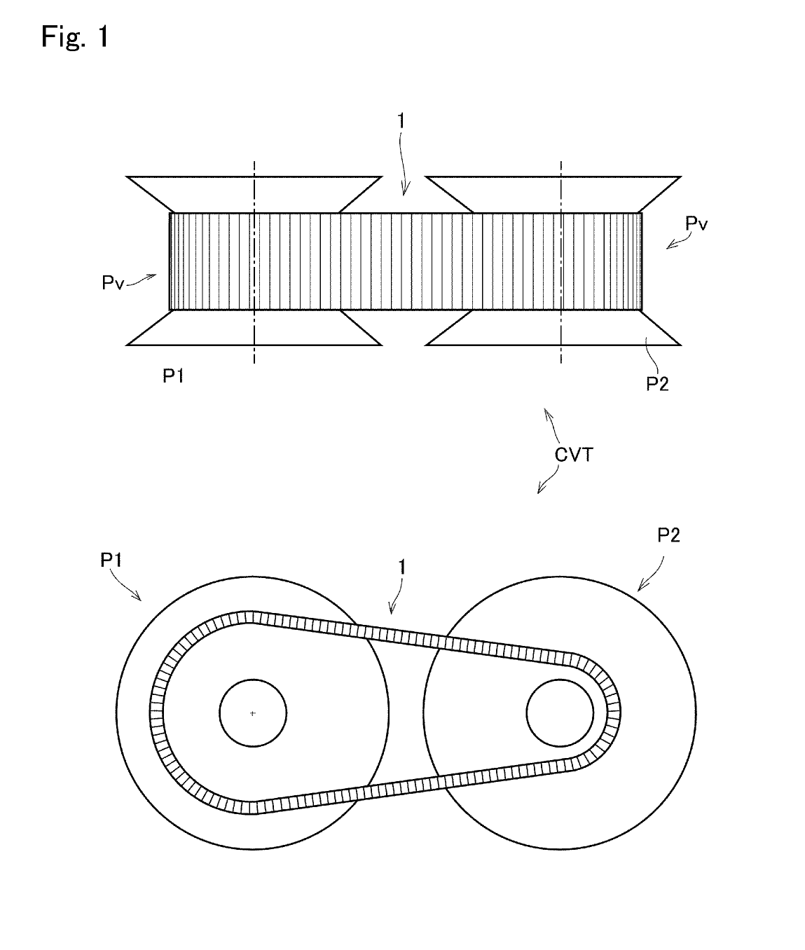

A driving belt which is a subject of the embodiments of the present disclosure is employed as a V belt of a belt-driven transmission that performs power transmission between two pulleys. For example, it is employed in a belt-driven continuously variable transmission installed in a vehicle. In the example shown in FIG. 1, a driving belt 1 is wound on respective pulley grooves Pv of a drive pulley P1 and a driven pulley P2 of a belt-driven continuously variable transmission CVT. Moreover, the driving belt 1 transmits a torque by a frictional force occurring between the driving belt 1 and the pulleys P1, P2.

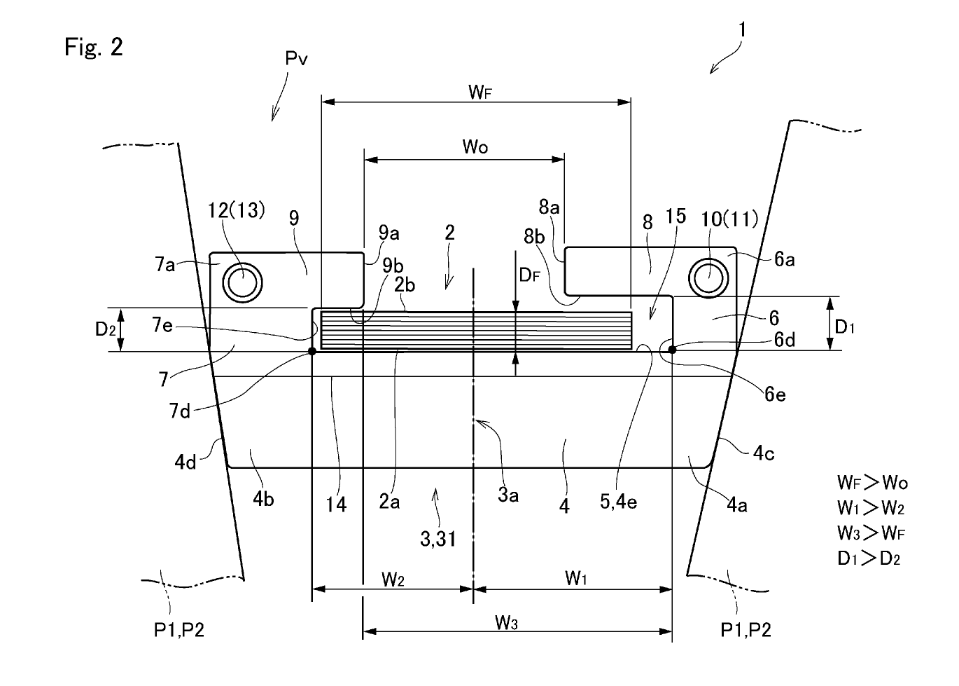

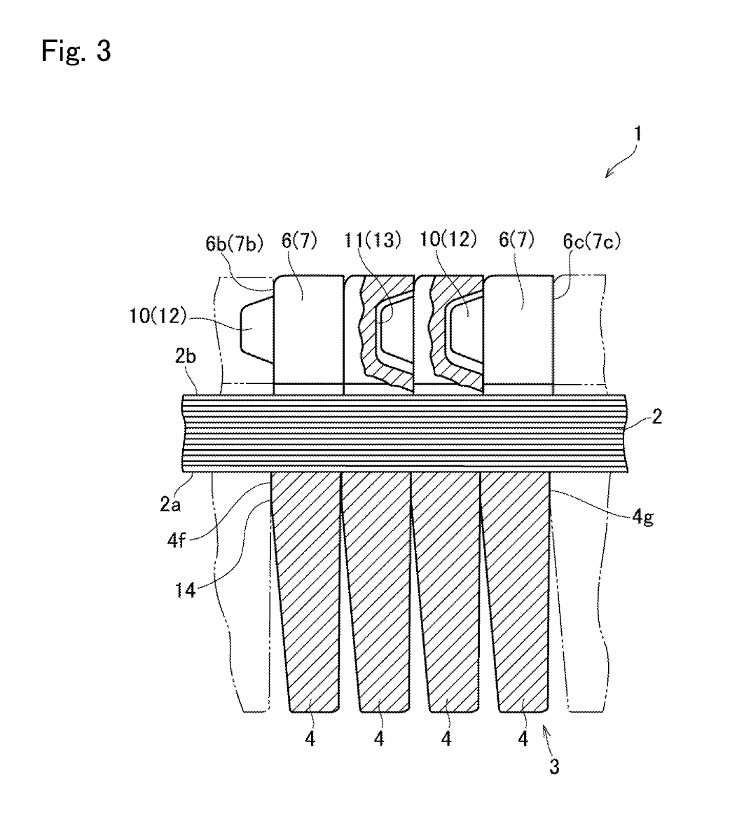

As shown in FIGS. 2 and 3, for example, the driving belt 1 includes a belt-like hoop 2 and a plurality of (for example, several hundred) plate-piece shaped elements 3. Moreover, the driving belt 1 is configured by arranging the plurality of elements 3 with their postures aligned and binding the elements 3 in loop form by the hoop 2.

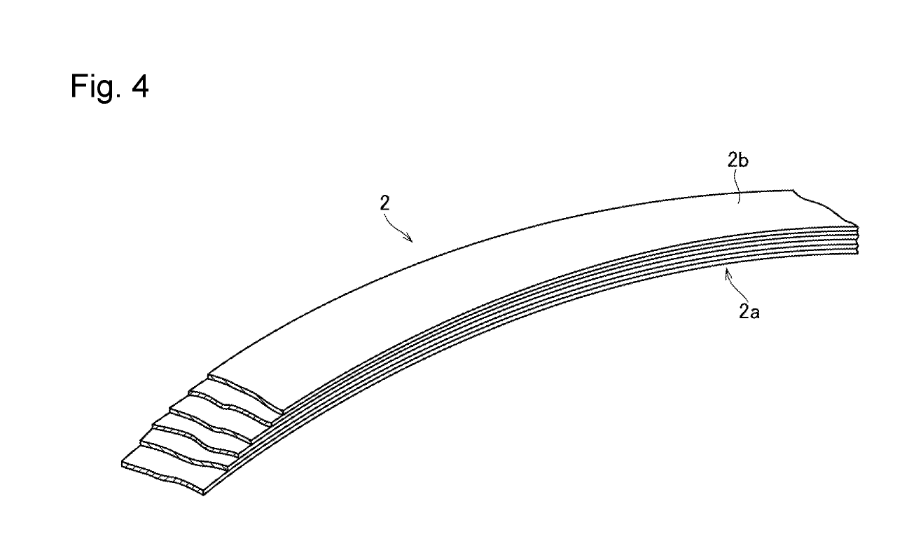

As described above, the hoop 2 is a member for holding bound in loop form the plurality of elements. Hence, the hoop 2 is required to have both sufficient flexibility to enable its winding diameter to be freely changed and sufficient tensile strength to oppose a transmission torque or clamping force received from the pulleys P1, P2 during power transmission, at a time when the driving belt 1 is wound on the pulleys P1, P2. Therefore, as shown in FIG. 4, for example, the hoop 2 is configured by overlapping a plurality of belt-like members made of a metal and having flexibility, such as steel bands, in a thickness direction of the belt-like members.

Each of the element 3 is formed by a plate-piece shaped member made of a metal, for example. The element 3 includes the following as its main configuring elements, namely, a base section 4, a saddle surface 5, a first pillar section 6, a second pillar section 7, a first hook section 8, a second hook section 9, a first boss 10, a first dimple 11, a second boss 12, and a second dimple 13.

The base section 4 forms a main body portion of the element 3. One end section of the base section 4 in a width direction (a left-right direction of FIG. 2) of the element 3 configures a first end section 4a, and the other end section of the base section 4 in the width direction of the element 3 configures a second end section 4b. In the example shown in FIG. 2, the end section on a right side of the base section 4 configures the first end section 4a, and the end section on a left side of the base section 4 configures the second end section 4b. An end surface 4c of the first end section 4a and an end surface 4d of the second end section 4b are each formed as inclined surfaces that are inclined parallel to tapered surfaces of the pulley groove Pv. These left and right end surfaces 4c, 4d are so-called flank surfaces of the element 3, and make frictional contact with the pulley groove Pv to transmit a torque between the pulleys P1, P2 and the driving belt 1.

The saddle surface 5 is a surface contacting an inner peripheral surface 2a of the hoop 2 in a state where the elements 3 and the hoop 2 have been assembled, and is formed in an end surface 4e on an upper end side of the base section 4 in a height direction (an up-down direction of FIGS. 2 and 3) of the element 3. Specifically, the saddle surface 5 is formed in the end surface 4e between the first pillar section 6 and the second pillar section 7 respectively formed in both end sections 4a, 4b of the base section 4, as will be mentioned later.

The first pillar section 6 is erected on the saddle surface 5 in the first end section 4a of the base section 4. In the example shown in FIG. 2, the first pillar section 6 extends out upwardly in the height direction of the base section 4, from the first end section 4a on the right side in the width direction of the base section 4. The first pillar section 6 is formed integrally with the base section 4.

The second pillar section 7 is erected on the saddle surface 5 in the second end section 4b of the base section 4. In the example shown in FIG. 2, the second pillar section 7 extends out upwardly in the height direction of the base section 4, from the second end section 4b on the left side in the width direction of the base section 4. The second pillar section 7 is formed integrally with the base section 4.

Note that the above-described first end section 4a indicates a peripheral portion (including the end surface 4c) of one of the end sections (the end section on the right side of FIG. 2) of the base section 4 in the width direction of the element 3. Therefore, the first pillar section 6 may be formed so as to extend out upwardly in the height direction, from the first end section 4a including the end surface 4c. That is, the first pillar section 6 may be formed so as to extend out upwardly, having an inclined surface of the same inclination angle as the end surface 4c, continuously from the end surface 4c. On the other hand, the first pillar section 6 need not necessarily include the end surface 4c. For example, the first pillar section 6 may be formed so as to extend out upwardly in the height direction, from the first end section 4a, without including the end surface 4c. That is, the first pillar section 6 may be formed so as to extend out upwardly, without being continuous with the end surface 4c. For example, the first pillar section 6 may be formed so as to extend out upwardly, from a position shifted to a center 3a side from the end surface 4c. In the example shown in FIG. 2, the first pillar section 6 stands up upwardly, perpendicularly or substantially perpendicularly to the saddle surface 5, without being continuous with the end surface 4c.

Similarly, the above-described second end section 4b indicates a peripheral portion (including the end surface 4d) of the other of the end sections (the end section on the left side of FIG. 2) of the base section 4 in the width direction of the element 3. Therefore, the second pillar section 7 may be formed so as to extend out upwardly in the height direction, from the second end section 4b including the end surface 4d. That is, the second pillar section 7 may be formed so as to extend out upwardly, having an inclined surface of the same inclination angle as the end surface 4d, continuously from the end surface 4d. On the other hand, the second pillar section 7 need not necessarily include the end surface 4d. For example, the second pillar section 7 may be formed so as to extend out upwardly in the height direction, from the second end section 4b, without including the end surface 4d. That is, the second pillar section 7 may be formed so as to extend out upwardly, without being continuous with the end surface 4d. For example, the second pillar section 7 may be formed so as to extend out upwardly, from a position shifted to the center 3a side from the end surface 4d. In the example shown in FIG. 2, the second pillar section 7 stands up upwardly, perpendicularly or substantially perpendicularly to the saddle surface 5, without being continuous with the end surface 4d.

Therefore, in the example shown in FIG. 2, neither of the first pillar section 6 and the second pillar section 7 ever makes contact with the pulleys P1, P2, and neither receives a load from the pulleys P1, P2. That is, the first pillar section 6 and the second pillar section 7 are not acted on by a force directed in the width direction of the element 3 from the pulleys P1, P2. As a result, durability or reliability of the first pillar section 6 and the second pillar section 7 improve.

The first hook section 8 is formed so as to extend out from the first pillar section 6 toward the center 3a of the base section 4 in the width direction of the element 3. Specifically, the first hook section 8 projects toward the center 3a, from an upper end section 6a of the first pillar section 6 in the height direction of the base section 4. The first hook section 8 is formed integrally with the first pillar section 6 and the base section 4.

Now, the center 3a is a center in terms of a shape of the base section 4 in the width direction of the element 3, or a center in terms of a dimension of the base section 4 in the width direction of the element 3. That is, the center 3a is a central line indicating a central position in the width direction of the element 3, and is a portion indicating a position equally dividing a distance between the end surface 4c of the first end section 4a and the end surface 4d of the second end section 4b.

The second hook section 9 is formed so as to extend out from the second pillar section 7 toward the center 3a of the base section 4 in the width direction of the element 3. Specifically, the second hook section 9 projects toward the center 3a, from an upper end section 7a of the second pillar section 7 in the height direction of the base section 4. The second hook section 9 is formed integrally with the second pillar section 7 and the base section 4.

The first boss 10 is formed in the upper end section 6a of the first pillar section 6. Specifically, the first boss 10 projects to the outside from a front surface 6b as one surface of the first pillar section 6 in a plate thickness direction (the left-right direction of FIG. 3) of the upper end section 6a. The first boss 10 is formed so as to loosely fit together with the first dimple 11 of an adjacent other element 3 in a state where the elements 3 and the hoop 2 have been assembled.

The first dimple 11 is formed in the upper end section 6a of the first pillar section 6. Specifically, the first dimple 11 recesses to the inside from a rear surface 6c as the other surface of the first pillar section 6 in the plate thickness direction of the upper end section 6a. The first dimple 11 is formed so as to loosely fit together with the first boss 10 of an adjacent other element 3 in a state where the elements 3 and the hoop 2 have been assembled. Therefore, in the driving belt 1, the first boss 10 and the first dimple 11 fit together in the fellow elements 3 adjacent in the peripheral direction of the hoop 2.

Similarly, the second boss 12 is formed in the upper end section 7a of the second pillar section 7. Specifically, the second boss 12 projects to the outside from a front surface 7b as one surface of the second pillar section 7 in the plate thickness direction of the upper end section 7a (i.e., in the horizontal direction in FIG. 3). The second boss 12 is formed so as to loosely fit together with the second dimple 13 of an adjacent other element 3 in a state where the elements 3 and the hoop 2 have been assembled.

The second dimple 13 is formed in the upper end section 7a of the second pillar section 7. Specifically, the second dimple 13 recesses to the inside from a rear surface 7c as the other surface of the second pillar section 7 in the plate thickness direction of the upper end section 7a. The second dimple 13 is formed so as to loosely fit together with the second boss 12 of an adjacent other element 3 in a state where the elements 3 and the hoop 2 have been assembled. Therefore, in the driving belt 1, the second boss 12 and the second dimple 13 fit together in the fellow elements 3 adjacent in the peripheral direction of the hoop 2.

By the first boss 10 and first dimple 11, and the second boss 12 and second dimple 13 respectively fitting together as described above, fellow adjacent elements 3 are positioned, and relative movement of those fellow adjacent elements 3 is restricted.

Moreover, the elements 3 are bound by the hoop 2 in a circular manner in the same orientation, and are wound on the pulleys P1, P2. In the pulley grooves Pv of the pulleys P1, P2, the elements 3 are spread like a fan with respect to centers of the pulleys P1, P2, and the elements 3 are also in close contact with each other. Therefore, a thickness of a portion on a lower side of the base section 4 in the height direction of the element 3 is reduced gradually. Specifically, a rocking edge 14 is formed at a certain position more to the lower side than the saddle surface 5 in a front surface 4f as one surface of the base section 4 in the plate thickness direction. The thickness of the base section 4 is thinned from the rocking edge 14 to the lower side than the rocking edge 14. In the pulley grooves Pv of the pulleys P1, P2, therefore, the rocking edge 14 contacts a rear surface 4g of the base section 4 of an adjacent other element 3.

As shown in FIG. 2, the driving belt 1 in the embodiment of the present disclosure is formed in such a manner that an opening width W_{O} between a tip section 8a of the first hook section 8 and a tip section 9a of the second hook section 9 is narrower than a width W_{F} of the hoop 2. The tip section 8a and the tip section 9a face each other in the width direction of the element 3. The opening width W_{O} is a dimension of between the tip section 8a and the tip section 9a, and is a distance of a portion where it becomes narrowest between the tip section 8a and the tip section 9a in the width direction of the element 3. By the opening width W_{O} of the element 3 being narrower than the width W_{F} of the hoop 2 in this way, shedding from the hoop 2 of the elements 3 is prevented in a state where the elements 3 and the hoop 2 have been assembled, as will be mentioned later.

Moreover, the driving belt 1 in the embodiment of the present disclosure is formed in such a manner that a first width W₁ from the center 3a of the element 3 to a base corner 6d of the first pillar section 6 is wider than a second width W₂ from the center 3a to a base corner 7d of the second pillar section 7, and in such a manner that a third width W₃ from the base corner 6d of the first pillar section 6 to the tip section 9a of the second hook section 9 is wider than the width W_{F} of the hoop 2. The base corner 6d is a portion where an inner wall surface 6e of the first pillar section 6 and the saddle surface 5 intersect, and the base corner 7d is a portion where an inner wall surface 7e of the second pillar section 7 and the saddle surface 5 intersect. The inner wall surface 6e and the inner wall surface 7e face each other in the width direction of the element 3. The first width W₁ is a dimension of between the center 3a and the base corner 6d, that is, a distance between the center 3a and the base corner 6d in the width direction of the element 3. The second width W₂ is a dimension of between the center 3a and the base corner 7d, that is, a distance between the center 3a and the base corner 7d in the width direction of the element 3. The third width W₃ is a dimension of between the base corner 6d and the tip section 9a, and is a distance of a portion where it becomes narrowest between the base corner 6d and the tip section 9a in the width direction of the element 3. The width W_{F} is a dimension of between both side surfaces in the width direction of the hoop 2.

Note that in the driving belt 1 in the embodiment of the present disclosure, the element 3 may be formed in such a manner that the above-described third width W₃ is narrower than the width W_{F} of the hoop 2. As previously mentioned, the hoop 2 is formed by a belt-like member having flexibility such as a steel band, for example. Therefore, the hoop 2 may be deformed (flexed, or curved) in such a manner that both end portions in the width direction of the hoop 2 approach each other. Hence, by deforming the hoop 2 in that way, the width W_{F} of the hoop 2 can temporarily be made narrower than the third width W₃. Therefore, it is possible for the elements 3 and the hoop 2 to be assembled even if the third width W₃ is narrower than the width W_{F} of the hoop 2.

As described above, in the element 3, the first width W₁ is wider than the second width W₂. That is, in the element 3, a shape on the saddle surface 5 where the hoop 2 is disposed, is configured asymmetrically to left and right in the width direction. Specifically, a space surrounded by the first hook section 8, the first pillar section 6, and the saddle surface 5 is configured wider than a space surrounded by the second hook section 9, the second pillar section 7, and the saddle surface 5. This wide space surrounded by the first hook section 8, the first pillar section 6, and the saddle surface 5 configures the space-for-assembly 15 into which an end section of the hoop 2 is initially inserted when the elements 3 and the hoop 2 are assembled.

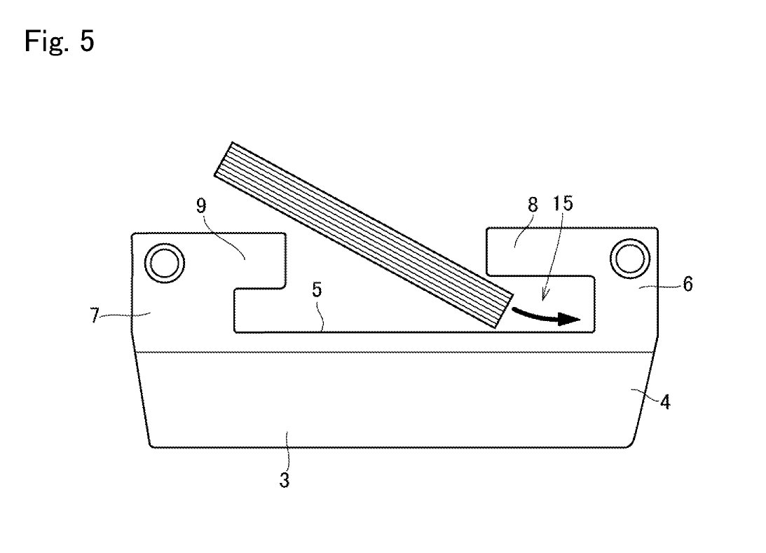

Therefore, in an initial stage of assembly when the elements 3 and the hoop 2 are assembled, one end section in the width direction of the hoop 2 is inserted obliquely toward the space-for-assembly 15 of the element 3, as shown in FIG. 5. Alternatively, the element 3 is inclined with respect to the hoop 2 to fit the space-for-assembly 15 of the element 3 to the one end section in the width direction of the hoop 2. In that case, due to the third width W₃ being wider than the width W_{F} of the hoop 2 as described above, the hoop 2 can be easily disposed on the saddle surface 5 of the element 3, without the hoop 2 ever being deformed. Therefore, the elements 3 and the hoop 2 can be easily assembled. In addition, since the hoop 2 need not be deformed, a force applied to the hoop 2 during assembly can be reduced. Therefore, durability or reliability of the hoop 2 improves. Moreover because, as described above, the opening width W_{O} of the element 3 is narrower than the width W_{F} of the hoop 2, it can be prevented that the elements 3 get shed from the hoop 2 after the hoop 2 has been disposed on the saddle surface 5.

Note that a crown (not illustrated) projecting upwardly in the height direction at the center 3a may be formed in the saddle surface 5. By providing such a crown or crown-like shape in the saddle surface 5, a position of the hoop 2 in the width direction of the element 3 can be aligned during running of the driving belt 1. Therefore, the hoop 2 can be disposed in a prescribed position where a center in the width direction of the hoop 2 and the center 3a of the element 3 coincide, or a position close to that prescribed position.

In the driving belt 1, a first clearance D₁ between the saddle surface 5 and a lower surface 8b of the first hook section 8 is wider than a second clearance D₂ between the saddle surface 5 and a lower surface 9b of the second hook section 9, and the second clearance D₂ is wider than a thickness D_{F} of the hoop 2. The lower surface 8b is a surface facing the saddle surface 5, of the first hook section 8, and, in a state where the elements 3 and the hoop 2 have been assembled, faces an outer peripheral surface 2b of the hoop 2, and prevents shedding from the hoop 2 of the elements 3. The lower surface 9b is a surface facing the saddle surface 5, of the second hook section 9, and, in a state where the elements 3 and the hoop 2 have been assembled, faces the outer peripheral surface 2b of the hoop 2, and prevents shedding from the hoop 2 of the elements 3. The first clearance D₁ is a dimension of between the saddle surface 5 and the lower surface 8b, and is a distance of a portion where it becomes narrowest between the saddle surface 5 and the lower surface 8b in the height direction of the element 3. The second clearance D₂ is a dimension of between the saddle surface 5 and the lower surface 9b, and is a distance of a portion where it becomes narrowest between the saddle surface 5 and the lower surface 9b in the height direction of the element 3. The thickness D_{F} is a dimension of between the inner peripheral surface 2a and the outer peripheral surface 2b of the hoop 2, and is a distance of a portion where it becomes thickest between the inner peripheral surface 2a and the outer peripheral surface 2b in a thickness direction of the hoop 2. The second clearance D₂ is configured to be slightly larger than the thickness D_{F} to an extent that, when the elements 3 and the hoop 2 are assembled and in a normal state after the elements 3 and the hoop 2 have been assembled, the second hook section 9 does not restrict movement of the hoop 2.

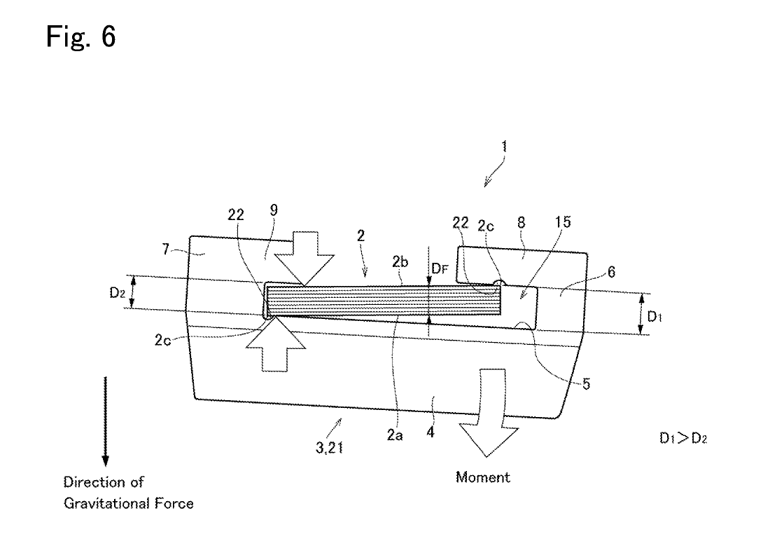

Thus, in the embodiment of the present disclosure, the first clearance D₁ is larger than the second clearance D₂. Therefore, when gravity is applied to the element 3 in the direction to disengage the element 3 from the hoop 2, as illustrated in FIG. 6, the first hook section 8 side of the element 3 in which the first clearance D₁ is relatively larger sags under the influence of gravity. That is, the first hook section 8 side of the element 3 is subjected to a moment derived from its own weight. As described, in the second hook section 9 side, the second clearance D₂ to which is one end section in the width direction of the hoop 2 is inserted is relatively narrow. In the second hook section 9 side, therefore, an inner edge 2c of the hoop 2 is brought into contact to the saddle surface 5, and the outer peripheral surface 2b of the hoop 2 is brought into contact to the lower surface 9b of the second hook section 9. Consequently the hoop 2 is stuck between the second hook section 9 and the saddle surface 5 and hence a lateral movement of the hoop 2 in the width direction of the element 3 is prevented.

As previously mentioned, in order to make assembly of the elements 3 and the hoop 2 easy, the first width W₁ on the first pillar section 6 side from the center 3a is configured wider than the second width W₂ on the second pillar section 7 side from the center 3a. That is, the space-for-assembly 15 is formed on a first hook section 8 side. Moreover, the third width W₃ is configured larger than the width W_{F} of the hoop 2. Therefore, when the element 3 hangs on the hoop 2 under the influence of gravity, the element 3 may be disengaged from the hoop 2 by its own weight if the hoop 2 moves toward the space-for-assembly 15. In order to prevent such disengagement of the element 3 from the hoop 2, the first clearance D₁ is configured wider than the second clearance D₂ to restrict a movement of the hoop 2 in the width direction of the element 3.

In addition, since the first clearance D₁ is wider than the second clearance D₂, width end section of the hoop 2 may be inserted easily into the space-for-assembly 15 of the element 3. That is, the element 3 may be engaged easily with the hoop 2.

The driving belt 1 in the embodiment of the present disclosure is not limited to the above-described configuration shown in FIGS. 2 and 3. For example, as shown in FIG. 6, a recess for restricting a movement of the hoop 2 may be formed in the element 3. Note that in the driving belt 1 shown in FIG. 6, a configuring element whose configuration or function is the same as in the previously mentioned driving belt 1 shown in FIGS. 2 and 3, is assigned with the same reference symbol as in FIGS. 2 and 3.

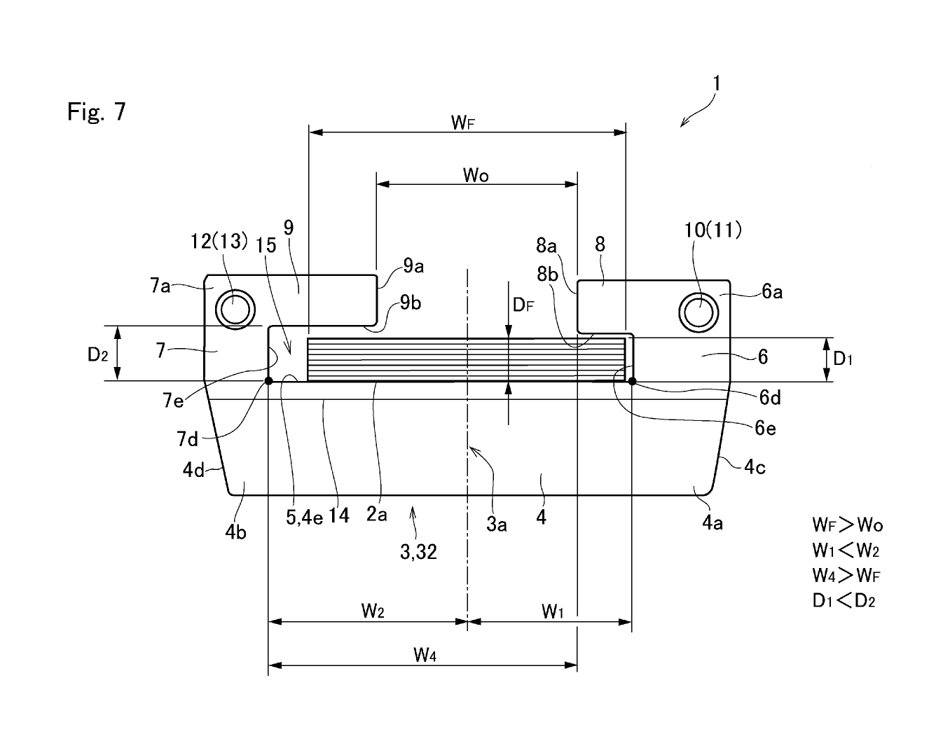

The driving belt 1 shown in FIG. 7 is configured from the hoop 2 and elements 21. The element 21 basically has a similar configuration to that of the previously mentioned element 3, but a recess 22 for stopping the hoop 2 is formed on the element 21.

The recess 22 may be formed on at least one of the lower surface 8b of the first hook section 8 and the saddle surface 5 opposed to the lower surface 9b of the second hook section 9. In the example shown in FIG. 6, the recesses 22 are formed on both of the lower surface 8b of the first hook section 8, and the saddle surface 5 opposed to the lower surface 9b of the second hook section 9. When the first hook section 8 side of the element 3 sags under its own weight, the inner edge 2c of the hoop 2 between one of side faces and the inner peripheral surface 2a is engaged with the recess 22 formed on the saddle surface 5 opposed to the lower surface 9b of the second hook section 9, and an outer edge 2c of the hoop 2 between the other side face and the outer peripheral surface 2b is engaged with the recess 22 formed on the lower surface 8b of the first hook section 8.

As described, in the driving belt 1 according to the embodiment, the first clearance D₁ is configured wider than the second clearance D₂ so that the laterally end section of the hoop 2 is stuck between the second hook section 9 and the saddle surface 5. That is, the lateral movement of the hoop 2 in the width direction of the element 3 is restricted. In addition, in the example shown in FIG. 6, the recess 22 is formed in the element 21. For this reason, the lateral movement of the hoop 2 can be restricted more certainly to prevent disengagement of the element 21 from the hoop 2.

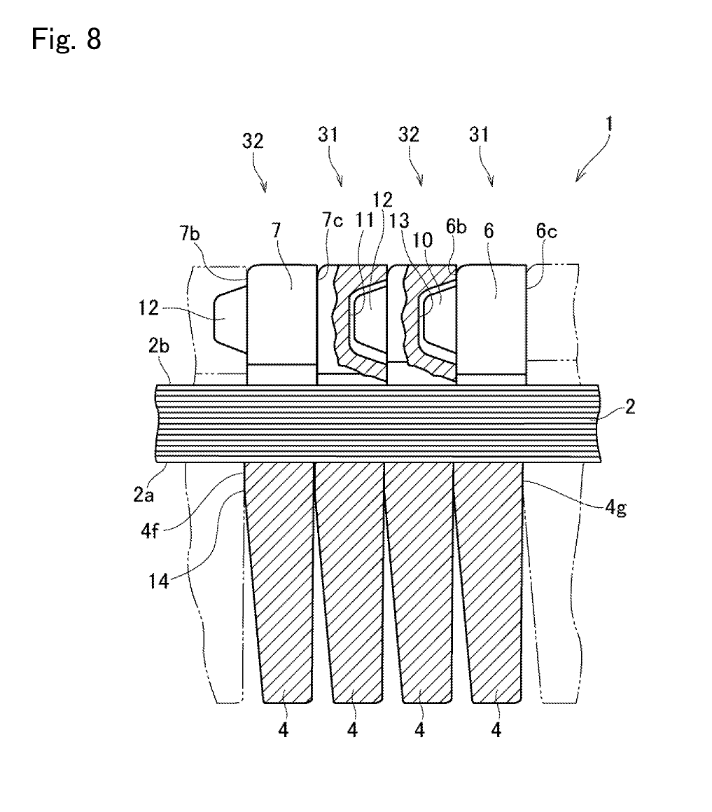

As shown in FIGS. 7 and 8, the driving belt 1 may also be formed using two kinds of the element such as a first element 31 and a second element 32. Note that in the driving belts shown in FIGS. 7 and 8, a configuring element whose configuration or function is the same as in the previously mentioned driving belt 1 shown in FIGS. 2 and 3, is assigned with the same reference symbol as in FIGS. 2 and 3.

The first element 31 is the element 3 shown in FIGS. 2 and 3. In the first element 31, accordingly, the first width W₁ is wider than the second width W₂, the third width W₃ is wider than the width W_{F} of the hoop 2, and the first clearance D₁ is wider than the second clearance D₂.

On the other hand, in the second element 32, the second width W₂ is wider than the first width W₁, a fourth width W₄ between the base corner 7d and the tip section 8a of the first hook section 8 is wider than the width W_{F} of the hoop 2, and the second clearance D₂ is wider than the first clearance D₁. Thus, in the second element 32, configurations of the first pillar section 6 and the first hook section 8, and configurations of the second pillar section 7 and the second hook section 9 are opposite to those in the first element 31. In the second element 32, accordingly, a space surrounded by the second hook section 9, the second pillar section 7, and the saddle surface 5 configures the space-for-assembly 15.

As illustrated in FIG. 8, the first elements 31 and the second elements 32 are juxtaposed alternately. Instead, an array of predetermined number of the first elements 31 and an array of predetermined number of the second elements 32 may also be juxtaposed alternately. Further, the first elements 31 and the second elements 32 may also be juxtaposed at random. That is, the first elements 31 and the second elements 32 are used substantially evenly to form the driving belt 1.

By thus using the first element 31 and the second element 32 to form the driving belt 1, the lateral movement of the hoop 2 can be restricted from both sides in the width direction of the elements 31, 32. For this reason, disengagement of the first element 31 and the second element 32 from the hoop 2 can be prevented more certainly. Optionally, the recess 22 shown in FIG. 6 may also be formed in the first element 31 and the second element 32 to restrict the lateral movement of the hoop 2 more certainly.

In the first element 31 the third width W₃ may also be configured narrower than the width W_{F} of the hoop 2. Likewise, in the second element 32, the fourth width W₄ may also be narrower than the width W_{F} of the hoop 2. As described, the width W_{F} of the hoop 2 can temporarily be made narrower than the third width W₃ by deforming the hoop 2. In this case, therefore, the hoop 2 may be engaged with the first element 31 and the second element 32 even if the third width W₃ and the fourth width W₄ are narrower than the width W_{F} of the hoop 2.

In contrast, in the example shown in FIG. 8, both of the third width W₃ and the fourth width W₄ are wider than the width W_{F} of the hoop 2, and hence the hoop 2 may be mounted easily on the saddle surfaces 5 of the first element 31 and the second element 32. That is, the hoop 2 may be engaged with the first element 31 and the second element 32 without deforming the hoop 2 by applying force to the hoop 2. Therefore, the hoop 2 can be prevented from being damaged during the assemble work.

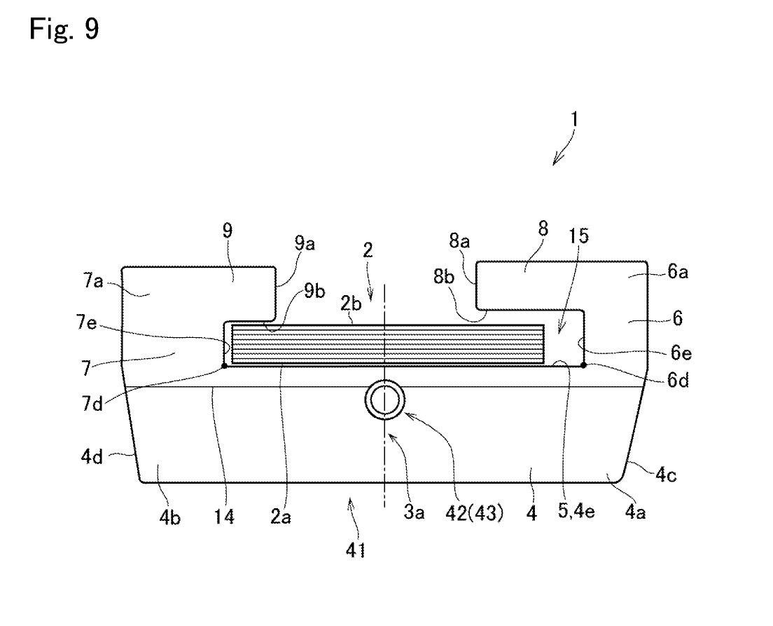

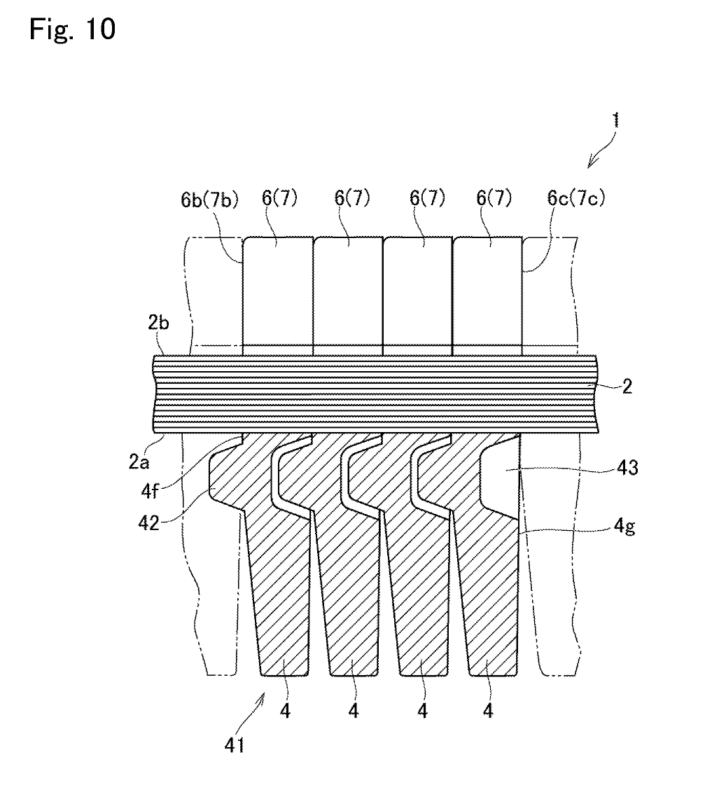

Moreover, in the driving belt 1 in the embodiment of the present disclosure, it is also possible that, for example, as shown in the previously mentioned FIGS. 9 and 10, one pair of a boss 42 and a dimple 43 is provided in the central portion of the element 41. Note that in the driving belts shown in FIGS. 9 and 10, a configuring element whose configuration or function is the same as in the previously mentioned driving belt 1 shown in FIGS. 2 and 3, is assigned with the same reference symbol as in FIGS. 2 and 3.

The driving belts 1 shown in FIGS. 9 and 10 are configured from the hoop 2 and elements 41. The element 41 basically has a similar configuration to that of the previously mentioned element 3, but is provided with the boss 42 and the dimple 43 instead of the first boss 10, the first dimple 11, the second boss 12, and the second dimple 13 in the element 3.

The boss 42 is formed in a central portion (a vicinity of the center 3a) of the base section 4 of the element 41. Specifically, the boss 42 projects to the outside from the front surface 4f as one surface in the plate thickness direction (the left-right direction of FIG. 10) of the base section 4. The boss 42 is formed so as to loosely fit together with the dimple 43 of an adjacent other element 41 in a state where the elements 41 and the hoop 2 have been assembled.

The dimple 43 is formed in the central portion (the vicinity of the center 3a) of the base section 4 of the element 41. Specifically, the dimple 43 recesses to the inside from the rear surface 4g as the other surface in the plate thickness direction of the base section 4. The dimple 43 is formed so as to loosely fit together with the boss 42 of an adjacent other element 41 in a state where the elements 41 and the hoop 2 have been assembled. Therefore, in the driving belt 1, the boss 42 and the dimple 43 fit together in the fellow elements 41 adjacent in the peripheral direction of the hoop 2.

By the boss 42 and the dimple 43 fitting together as described above, adjacent fellow elements 41 are positioned, and relative movement in the width direction (the left-right direction of FIG. 9) and the height direction (the up-down direction of FIG. 9) of the element 41, of those adjacent fellow elements 41, is restricted. Moreover, in these examples shown in FIGS. 9 and 10, the boss 42 and the dimple 43 fit together in one place close to the center 3a of the element 41. Therefore, the adjacent fellow elements 41, although having their above-described kind of relative movement in the width direction and the height direction restricted, are capable of relative rotation around a fitting-together section of the boss 42 and the dimple 43. As a result, when, for example, the elements 41 and the hoop 2 are being assembled, the fellow elements 41 can be relatively rotated to easily achieve a state like that shown in previously mentioned FIG. 5 where the element 21 is inclined with respect to the hoop 2. Hence, assembly characteristics of the element 41 and the hoop 2 improve.

Note that it is also possible for the boss 42 and the dimple 43 of this element 41 shown in FIGS. 9 and 10 to be provided instead of the first boss 10, the first dimple 11, the second boss 12, and the second dimple 13 in the previously mentioned elements 3, 31, and 32 shown in FIGS. 2, 3, 7, and 8. In addition, the recess 22 shown in FIG. 6 may also be formed in the element 41 to restrict the lateral movement of the hoop 2 more certainly.

What is claimed is:

1. A driving belt configured by arranging a plurality of plate-piece shaped elements and binding the elements in loop form by a belt-like hoop,
wherein the element comprises
a base section forming a main body portion,
a saddle surface formed at an upper end of the base section to contact an inner peripheral surface of the hoop,
a first pillar section erected from the upper end of the base section at a first end section of the base section in a width direction of the element,
a second pillar section erected from the upper end of the base section at a second end section of the base section in the width direction,
a first hook section extending out from the first pillar section toward a center of the element in the width direction, and
a second hook section extending out from the second pillar section toward the center,
an opening width between a tip section of the first hook section and a tip section of the second hook section is narrower than a width of the hoop,
a first width from the center to a base corner of the first pillar section is wider than a second width from the center to a base corner of the second pillar section,
a first clearance between the saddle surface and a lower surface of the first hook section facing the saddle surface is wider than a second clearance between the saddle surface and a lower surface of the second hook section facing the saddle surface, and
the second clearance is wider than the thickness of the hoop.

2. The driving belt as claimed in claim 1, wherein a third width from the base corner of the first pillar section to the tip section of the second hook section of the element is wider than the width of the hoop.

3. The driving belt as claimed in claim 1, wherein a recess to which an edge of the hoop is engaged to restrict a movement of the hoop is formed on at least one of the lower surface of the first hook section and the saddle surface opposed to the lower surface of the second hook section.

4. The driving belt as claimed in claim 1, wherein
the element further comprises:
a first boss projecting to the outside from a front surface of the first pillar section in a thickness direction of the element;
a first dimple recessing to the inside from a rear surface of the first pillar section in the thickness direction;
a second boss projecting to the outside from a front surface of the second pillar section in the thickness direction; and
a second dimple recessing to the inside from a rear surface of the second pillar section in the thickness direction, and
in the fellow elements adjacent in a peripheral direction of the hoop, the first boss and the first dimple fit together, and the second boss and the second dimple fit together.

5. The driving belt as claimed in claim 1, wherein
the element further comprises:
a boss projecting to the outside from the center of a front surface of the base section in the thickness direction of the element; and
a dimple recessing to the inside from the center of a rear surface of the base section in the thickness direction, and
in the fellow elements adjacent in a peripheral direction of the hoop, the boss and the dimple fit together.

6. The driving belt as claimed in claim 1, wherein
the element includes
a first element in which the first width is wider than the second width, and the first clearance is wider than the second clearance, and
a second element in which the second width is wider than the first width, and the second clearance is wider than the first clearance and,
the first elements and the second elements are juxtaposed alternately in a predetermined pattern or at random.

7. The driving belt as claimed in claim 6, wherein
a third width from the base corner of the first pillar section to the tip section of the second hook section of the first element is wider than the width of the hoop, and
a fourth width from the base corner of the second pillar section to the tip section of the first hook section of the second element is wider than the width of the hoop.
